(19) United States
(12) Patent Application Publication
(10) Pub. No.: US 2026/0206865 A1
(43) Pub. Date: Jul. 23, 2026

(54) ATOMIZER AND ELECTRONIC ATOMIZATION DEVICE

(71) Applicant: SHENZHEN FIRST UNION TECHNOLOGY CO., LTD., Shenzhen (CN)

(72) Inventor: Liangjie SU, Shenzhen (CN)

(73) Assignee: SHENZHEN FIRST UNION TECHNOLOGY CO., LTD., Shenzhen (CN)

(21) Appl. No.: 19/453,613

(22) Filed: Jan. 20, 2026

(30) Foreign Application Priority Data
Jan. 21, 2025 (CN) 202510109612.2

(51) Int. Cl. A24F 40/485; A24F 40/10; A24F 40/42; A24F 40/44; H05B 3/06

(52) U.S. Cl. CPC A24F 40/485; A24F 40/10; A24F 40/42; A24F 40/44; H05B 3/06; H05B 2203/016; H05B 2203/021

(57) ABSTRACT

An atomizer includes a near end and a far end opposite to each other; a liquid storage cavity, configured to store a liquid substrate, where the liquid storage cavity includes a liquid outlet provided toward the far end; an atomization assembly, arranged to receive the liquid substrate in the liquid storage cavity through the liquid outlet, and atomize the liquid substrate to generate an aerosol; and a ventilation channel, where the ventilation channel provides a channel path for air to enter the liquid storage cavity, to adjust pressure in the liquid storage cavity; the ventilation channel includes an air outlet port located on an inner surface of the liquid storage cavity, and the air outlet port is provided avoiding the liquid outlet; and a first distance between the liquid outlet and the near end is greater than a second distance between the air outlet port and the near end.

### CROSS-REFERENCE TO RELATED APPLICATION

This application claims priority to Chinese Patent Application No. CN 202510109612.2, filed with China National Intellectual Property Administration on Jan. 21, 2025 and entitled “Atomizer and Electronic Atomization Device”, the entire contents of which are incorporated herein by reference for all purposes. No new matter has been introduced.

### TECHNICAL FIELD

This application relates to the field of electronic atomization technologies, and in particular, to an atomizer and an electronic atomization device.

### BACKGROUND

Tobacco products (such as cigarettes and cigars) burn tobacco during use to produce tobacco smoke. Attempts are made to replace these tobacco-burning products by making products that release compounds without burning.

An example of this type of products is a heating device that releases the compounds by heating rather than burning materials. For example, the materials may be tobacco or other non-tobacco products. These non-tobacco products may include or not include nicotine. As another example, there are aerosol-providing products, for example, so-called electronic atomization devices. These devices usually contain liquid substrates, and the liquid substrates are heated to vaporize, so as to generate an inhalable aerosol. The liquid substrates may contain nicotine and/or aromatics and/or aerosol-generation substances (such as glycerin). A known electronic atomization device includes a liquid storage cavity for storing a liquid substrate, and an atomization assembly for atomizing the liquid substrate to generate an aerosol. In addition, a ventilation channel that communicates the liquid storage cavity with external air is provided in the electronic atomization device, to adjust pressure of the liquid storage cavity. The ventilation channel is usually provided near a liquid outlet of the liquid storage cavity. During use, after air enters the liquid storage cavity from the ventilation channel, air bubbles easily form to block the liquid outlet.

### SUMMARY

An embodiment of this application provides an atomizer, including a near end and a far end opposite to each other,

a liquid storage cavity, configured to store a liquid substrate, where the liquid storage cavity includes a liquid outlet provided toward the far end;

an atomization assembly, arranged to receive the liquid substrate in the liquid storage cavity through the liquid outlet, and atomize the liquid substrate to generate an aerosol; and

a ventilation channel, where the ventilation channel provides a channel path for air to enter the liquid storage cavity, to adjust pressure in the liquid storage cavity; the ventilation channel includes an air outlet port located on an inner surface of the liquid storage cavity, and the air outlet port is provided avoiding the liquid outlet; and a first distance between the liquid outlet and the near end is greater than a second distance between the air outlet port and the near end.

In some embodiments, the first distance is at least 2 mm greater than the second distance.

In some embodiments, the atomizer further includes:

a first separation wall, extending and arranged in a longitudinal direction of the atomizer, where the liquid outlet is located on a first side of the first separation wall, and the ventilation channel and/or the air outlet port are/is located on a second side of the first separation wall.

In some embodiments, the atomizer further includes:

a holding cavity, formed or located on the first side of the first separation wall, and at least partially separated or defined by the first separation wall, where the atomization assembly is accommodated or held in the holding cavity; and

an air compartment, formed or located on the second side of the first separation wall, and at least partially separated or defined by the first separation wall.

In some embodiments, an air channel is in communication with the air compartment and the liquid storage cavity.

In some embodiments, the atomizer further includes:

a second separation wall, where the second separation wall is at least partially located between the liquid storage cavity and the air compartment, to isolate the liquid storage cavity from the air compartment.

In some embodiments, the ventilation channel at least partially passes through the second separation wall; and/or

the ventilation channel is at least partially formed or provided in the second separation wall.

In some embodiments, the atomizer further includes:

an air guide element, at least partially running through the second separation wall from the air compartment to the liquid storage cavity.

In some embodiments, the ventilation channel is at least partially formed between the air guide element and the second separation wall.

In some embodiments, the atomizer further includes:

an air inlet, an air outlet, and an airflow channel located between the air inlet and the air outlet, where the airflow channel defines an airflow path that passes through an atomization surface from the air inlet to the air outlet, to transfer the aerosol to the air outlet; the airflow channel at least partially flows through the air compartment and/or the air guide element; and

the air guide element is capable of being heated by an airflow that flows through the air compartment and/or the air guide element, and then heats a liquid substrate near the air guide element to reduce viscosity of the liquid substrate.

In some embodiments, the second separation wall is arranged substantially perpendicular to the longitudinal direction of the atomizer, and an extending radian of the second separation wall in a circumferential direction of the atomizer is less than or equal to π.

In some embodiments, the liquid outlet and/or the air outlet port are provided deviating from a longitudinal central axis of the atomizer.

In some embodiments, the atomization assembly includes:

a porous body element, configured to receive and hold the liquid substrate from the liquid storage cavity, and including an atomization surface arranged toward the far end; and

a heating element, combined with or arranged on the atomization surface, and configured to heat the liquid substrate to generate the aerosol.

In some embodiments, the atomizer further includes:

an air inlet, an air outlet, and an airflow channel located between the air inlet and the air outlet, where the airflow channel defines the airflow path that passes through the atomization surface from the air inlet to the air outlet, to transfer the aerosol to the air outlet; and

a part of the airflow channel extends in the liquid storage cavity in the longitudinal direction of the atomizer, or a part of the airflow channel passes through the liquid storage cavity in the longitudinal direction of the atomizer.

In some embodiments, the part of the airflow channel that extends in the liquid storage cavity is substantially provided in the longitudinal central axis of the atomizer.

The atomization surface is arranged deviating from the longitudinal central axis of the atomizer.

In some embodiments, an area of the atomization surface is greater than a cross-sectional area of the part of the airflow channel that extends in the liquid storage cavity.

In some embodiments, a ratio of a cross-sectional area of the part of the airflow channel that extends in the liquid storage cavity to the area of the atomization surface ranges from 0.3 to 0.9.

In some embodiments, the atomizer further includes:

a first electrode and a second electrode, configured to guide a current on the heating element; and

a first electrical contact and a second electrical contact that are spaced apart, where the first electrical contact is configured to at least partially provide a conductive connection between the first electrode and the heating element; and the second electrical contact is configured to at least partially provide a conductive connection between the second electrode and the heating element.

In a some embodiments, the first electrical contact and the second electrical contact are constructed to extend and to be arranged in the longitudinal direction of the atomizer; and the first electrical contact and the second electrical contact have different extending lengths, outer diameters, or volumes.

In some embodiments, the first electrical contact and the second electrical contact abut against the atomization surface, and at least a part of the first electrical contact and at least a part of the second electrical contact provide support for the atomization assembly in a longitudinal direction.

In some embodiments, the first electrical contact forms a conducive connection with the first electrode in a first electrical connection manner, and the second electrical contact forms a conducive connection with the second electrode in a second electrical connection manner. The first electrical connection manner is different from the second electrical connection manner.

In some embodiments, the atomizer further includes:

an elastic first electrical connection element, where the elastic first electrical connection element is arranged between the first electrical contact and the first electrode, and a conductive connection between the first electrical contact and the first electrode is established; and the first electrical connection element is at least partially compressed between the first electrical contact and the first electrode; and/or

a bendable second electrical connection element, where the bendable second electrical connection element is bendably arranged between the second electrical contact and the second electrode, and a conductive connection between the second electrical contact and the second electrode is established.

In some embodiments, the atomization assembly further includes:

a flexible capillarity fiber element, configured to absorb the liquid substrate from the liquid storage cavity, where

the porous body element is arranged to indirectly absorb, from the capillarity fiber element, the liquid substrate from the liquid storage cavity.

In some embodiments, the atomization assembly further includes:

a rigid clamping element, combined with a side of the capillarity fiber element facing away from the porous body element, where the capillarity fiber element is clamped between the clamping element and the porous body element.

In some embodiments, the clamping element is liquid-permeable.

In some embodiments, the atomization surface is a plane that is arranged substantially perpendicular to the longitudinal direction of the atomizer.

Another embodiment of this application further provides an atomizer, including a near end and a far end opposite to each other in a longitudinal direction,

a liquid storage cavity, configured to store a liquid substrate, where the liquid storage cavity includes a liquid outlet provided toward the far end;

an atomization assembly, arranged to receive the liquid substrate in the liquid storage cavity through the liquid outlet, and atomize the liquid substrate to generate an aerosol;

a ventilation channel, where the ventilation channel provides a channel path for air to enter the liquid storage cavity, to adjust pressure in the liquid storage cavity; and the ventilation channel includes an air outlet port located on an inner surface of the liquid storage cavity, and the air outlet port is provided avoiding the liquid outlet; and

a first separation wall, extending and arranged in a longitudinal direction of the atomizer, where the liquid outlet and the atomization assembly are located on a first side of the first separation wall, and the ventilation channel and the air outlet port are located on a second side of the first separation wall; and the liquid outlet and the air outlet port are located at different height positions in the longitudinal direction of the atomizer.

Another embodiment of this application further provides an electronic atomization device, including the foregoing atomizer and a power supply mechanism that supplies power to the atomizer.

When the foregoing atomizer is in use, air bubbles formed when air enters the liquid storage cavity from the ventilation channel do not occupy the liquid outlet, and liquid guiding is not affected.

### BRIEF DESCRIPTION OF THE DRAWINGS

One or more embodiments are exemplarily described with reference to corresponding figures in accompanying drawings, and these exemplary descriptions do not constitute a limitation to the embodiments. Components in the accompanying drawings that have same reference numerals are represented as similar components, and unless otherwise particularly stated, the figures in the accompanying drawings are not drawn to scale.

FIG. 1 is a schematic diagram of an electronic atomization device according to an embodiment;

FIG. 2 is a schematic diagram of an embodiment of an atomizer in FIG. 1;

FIG. 3 is a schematic exploded view of the atomizer in FIG. 2 from a perspective;

FIG. 4 is a schematic exploded view of the atomizer in FIG. 3 from another perspective;

FIG. 5 is a schematic cross-sectional view of the atomizer in FIG. 2 from a perspective;

FIG. 6 is a schematic cross-sectional view of the atomizer in FIG. 2 from another perspective;

FIG. 7 is a schematic cross-sectional view of the atomizer in FIG. 2 from another perspective;

FIG. 8 is a schematic cross-sectional view of the atomizer in FIG. 2 from another perspective;

FIG. 9 is a schematic cross-sectional view of the atomizer in FIG. 2 from another perspective;

FIG. 10 is a schematic structural diagram of a main housing in FIG. 2 from another perspective;

FIG. 11 is a schematic exploded view of a sealing element and an atomization assembly in FIG. 3 before assembly; and

FIG. 12 is a schematic cross-sectional view of a sealing element and an atomization assembly in FIG. 3 after assembly.

### DETAILED DESCRIPTION

For ease of understanding of this application, this application is described in more detail below with reference to accompanying drawings and specific implementations.

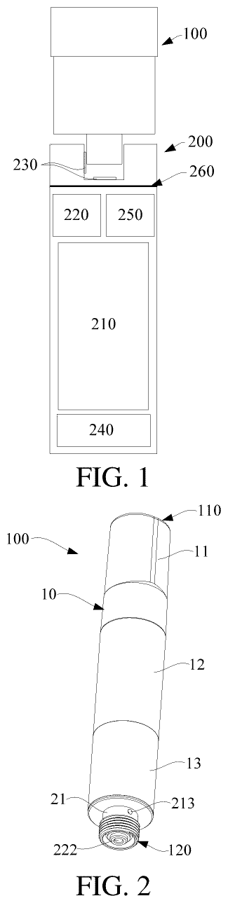

An embodiment of this application provides an electronic atomization device. Referring to FIG. 1, the electronic atomization device includes: an atomizer 100 that stores a liquid substrate and atomizes the liquid substrate to generate an aerosol, and a power supply mechanism 200 that supplies power to the atomizer 100. In an embodiment shown in FIG. 1, the atomizer 100 and the power supply mechanism 200 of the electronic atomization device may be detached relative to each other. The electronic atomization device with the atomizer 100 and the power supply mechanism 200 that are detached relative to each other is, for example, a so-called “refillable” electronic atomization device. Alternatively, in some other changeable embodiments, the atomizer 100 and the power supply mechanism 200 of the electronic atomization device are tightly wrapped and fixed by a housing component of the electronic atomization device, so that the atomizer 100 and the power supply mechanism 200 cannot be detached relative to each other from the inside of the housing component. The electronic atomization device with the atomizer 100 and the power supply mechanism 200 that cannot be detached relative to each other is, for example, a so-called “integral or one-time” electronic atomization device.

As shown in FIG. 1, the electronic atomization device includes the atomizer 100 that stores the liquid substrate and heats and vaporizes the liquid substrate to generate the aerosol, and the power supply mechanism 200 that supplies power to the atomizer 100.

In an optional implementation solution, for example, as shown in FIG. 1, the atomizer 100 and the power supply mechanism 200 may be removably combined with each other; and when the atomizer 100 is combined with the power supply mechanism 200, the power supply mechanism 200 can be configured to supply power to the atomizer 100, so that the atomizer 100 vaporizes the liquid substrate to generate the aerosol. Specifically, the atomizer 100 is removably combined with the power supply mechanism 200 including an end in a length direction; the power supply mechanism 200 includes an electrode contact 230; and the electrode contact 230 is configured to form an electrical connection with the atomizer 100 when the atomizer 100 is combined with the power supply mechanism 200, to further supply power to the atomizer 100.

According to the embodiment of FIG. 1, the atomizer 100 is at least partially protruded, and when the atomizer 100 is combined with the power supply mechanism 200, the protruding part of the atomizer 100 extends in the power supply mechanism 200, thereby forming detachable combination.

A sealing member 260 is arranged in the power supply mechanism 200, to provide sealing when the atomizer 100 is combined with the power supply mechanism 200. In a preferred implementation solution shown in FIG. 1, the sealing member 260 is constructed to extend in a cross section direction of the power supply mechanism 200, and is preferably prepared by using a flexible material such as silica gel, to further prevent the liquid substrate seeping from the atomizer 100 from flowing to a circuit board 220, an airflow sensor 250, and other components inside the power supply mechanism 200.

In the embodiment shown in FIG. 1, the power supply mechanism 200 further includes a battery cell 210 configured to supply power; and the circuit board 220, arranged between the battery cell 210 and the electrode contact 230, where the circuit board 220 operably guides a current between the battery cell 210 and the electrode contact 230.

The power supply mechanism 200 includes the airflow sensor 250, such as a microphone, or a barometric pressure sensor, and is configured to sense inhalation airflow generated when the atomizer 100 is inhaled by the user, so that the circuit board 220 controls the battery cell 210 to output power to the atomizer 100 according to a detection signal of the airflow sensor 250.

In a preferred embodiment shown in FIG. 1, a charging interface 240 is arranged on another end of the power supply mechanism 200 facing away from the atomizer 100, and is configured to charge the battery cell 210.

Embodiments in FIG. 2 to FIG. 5 are schematic structural diagrams of an embodiment of an atomizer 100 in FIG. 1. The atomizer 100 includes a plurality of components in an outer body or a housing 10 (which may be referred to as a housing). An overall design of the outer body or the housing 10 may be changeable, and a form or a configuration of the outer body that may define an overall size and a shape of the atomizer 100 is changeable. Generally, an elongated body may be formed by a single integral housing, or an elongated housing may be formed by two or more separable bodies. In some examples, the outer body or the housing 10 may be made of metal or an alloy such as stainless steel or aluminum. Other suitable materials include various types of plastic (for example, polycarbonate), metal-plating over plastic (metal-plating over plastic), ceramic, and the like. In addition, the overall outer body or the overall housing 10 is substantially cylindrical. Alternatively, in still some other embodiments, the overall outer body or the overall housing 10 may have a shape of a roughly cylinder, or a shape of a roughly elliptic cylinder, or a shape of a roughly flat cylinder with a length greater than a width and a width greater than a thickness, or another regular or irregular shape.

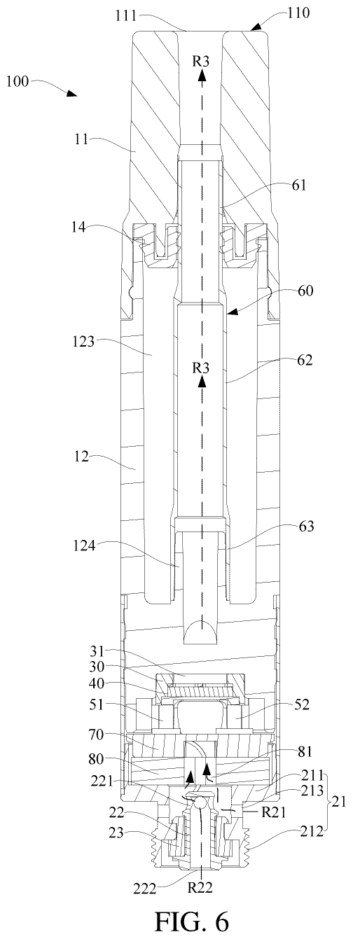

Referring to FIG. 2 to FIG. 7, the atomizer 100 has a near end 110 and a far end 120 that face away from each other in a longitudinal direction. During use, the near end 110 is an end close to a position at which a user performs inhalation, and the far end 120 is an end configured to be combined with the power supply mechanism 200. The outer body or the housing 10 of the atomizer 100 is jointly defined by a plurality of components. The components that specifically define the outer body or the housing 10 of the atomizer 100 include: a first housing 11 that is close to and defines the near end 110, a first electrode 21 that is close to and defines the far end 120, and a second housing 12 and a third housing 13 that are located between the first housing 11 and the first electrode 21 and extend in a longitudinal direction are substantially tubular. An air outlet 111 for the user to perform inhalation is provided on the near end 110 of the first housing 11.

In this embodiment, the first housing 11 at least partially surrounds the second housing 12, and is tightly connected to the second housing 12. Specifically, for example, a first connection structure 121 such as a clamping protrusion is arranged on a part of the second housing 12 that extends into the first housing 11, and a second connection structure such as a clamping slot is provided on an inner surface of the first housing 11. When the second housing 12 is partially inserted into the first housing 11, the first connection structure 121 such as the clamping protrusion is fitted with the second connection structure such as the clamping slot to provide a connection between the first housing 11 and the second housing 12.

In this embodiment, the third housing 13 at least partially surrounds the second housing 12, and is tightly connected to the second housing 12. Specifically, for example, a close fitting structure 122 such as a convex rib is arranged on a part of the second housing 12 that extends into the third housing 13. When the second housing 12 is partially inserted into the third housing 13, interference or close fitting is formed between the close fitting structure 122 such as the convex rib and the third housing 13, to provide a connection between the second housing 12 and the third housing 13.

Referring to FIG. 2 to FIG. 10, the outer body or the housing 10 forms or defines:

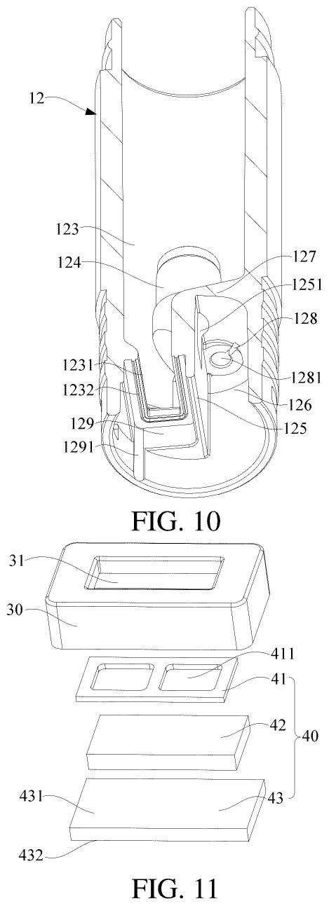

a liquid storage cavity 123, configured to store a liquid substrate. In this embodiment, the liquid storage cavity 123 is mainly formed in the second housing 12. In this embodiment, a side of the liquid storage cavity 123 that faces toward the near end 110 is sealed by a first sealing element 14. In this embodiment, a liquid outlet 1231 is provided on a side of the liquid storage cavity 123 that faces toward the far end 120, and the liquid outlet 1231 is provided for the liquid substrate to leave the liquid storage cavity 123. In the embodiment shown in FIG. 10, the liquid outlet 1231 is defined by the second housing 12. In addition, as shown in FIG. 10, the liquid outlet 1231 is located between the liquid storage cavity 123 and a holding cavity 129. In addition, as shown in FIG. 10, the liquid storage cavity 123 is in communication with the holding cavity 129 through the liquid outlet 1231. In addition, in this embodiment, the liquid outlet 1231 of the liquid storage cavity 123 is provided toward the far end 120.

Referring to FIG. 2 to FIG. 7, in the atomizer 100, a conductive connection is established between an electrode assembly 20 that is close to and defines the far end 120 and the power supply mechanism 200. Specifically, when the atomizer 100 is connected to the power supply mechanism 200, the electrode assembly 20 forms an electrical connection with an electrode contact 230, to further supply power to the atomizer 100. Specifically, the electrode assembly 20 includes:

a first electrode 21 and a second electrode 22. During use, one of the first electrode 21 and the second electrode 22 is used as a positive electrode, and the other of the first electrode 21 and the second electrode 22 is used as a negative electrode. In this embodiment, the first electrode 21 and the second electrode 22 are configured to supply power to an atomization assembly 40, or guide a current on a heating element of an atomization assembly 40.

In this embodiment, the first electrode 21 is constructed in an annular shape extending in a longitudinal direction; and the first electrode 21 has a first section 211 and a second section 212 that have different outer diameters, where the second section 212 is closer to the far end 120, and defines the far end 120. In this embodiment, the first section 211 is in an annular shape that is substantially arranged perpendicular to the longitudinal direction of the atomizer 100. The first section 211 has a relatively thin thickness, for example, a thickness of approximately 0.2 mm to 2.0 mm. In addition, the second section 212 is in a cylindrical shape that substantially extends in the longitudinal direction of the atomizer 100. For example, the second section 212 has a length ranging from 3 mm to 8 mm. In addition, a surface of the second section 212 is provided with an external thread, and the external thread is configured to form a detachable connection with an adaptive internal thread on the power supply mechanism 200.

In this embodiment, the second electrode 22 is in an annular shape that is substantially coaxially arranged with the first electrode 21. The second electrode 22 is accommodated and held in the second section 212 of the first electrode 21. Both the first electrode 21 and the second electrode 22 are prepared by using metal or an alloy with low resistivity, for example, gold, silver, copper, nickel, or an alloy thereof.

After assembly, a surface of the second electrode 22 at the far end 120 is substantially flush with the second section 212 of the first electrode 21, so that the second electrode 22 is at least partially exposed at the far end 120. Further, it is advantageous to enable the second section 212 of the first electrode 21 and the second electrode 22 to form a conductive contact with the power supply mechanism 200.

Referring to FIG. 2 to FIG. 7, the electrode assembly 20 further includes:

a flexible insulating element 23, where the flexible insulating element 23 is substantially in an annular shape, for example, a flexible silicone ring, and is located in the second section 212 of the first electrode 21 and surrounds the second electrode 22, to provide insulation between the second section 212 of the first electrode 21 and the second electrode 22.

Referring to FIG. 2 to FIG. 7, a first air inlet 213 is provided on the second section 212 of the first electrode 21, to allow external air to enter the atomizer 100 during inhalation. In addition, in this embodiment, the first air inlet 213 is provided to avoid the external thread on the outer surface of the second section 212.

Referring to FIG. 2 to FIG. 7, the second electrode 22 defines a second air inlet 222 facing toward the far end 120, to allow the external air to enter the atomizer 100 during inhalation.

In this embodiment, the atomizer 100 including both the first air inlet 213 and the second air inlet 222 may be compatible with more power supply mechanisms 200. For example, in some embodiments, when the atomizer 100 is combined with some power supply mechanisms 200, the power supply mechanisms 200 may cover and further close the first air inlet 213, and keep the second air inlet 222 open, to allow air to enter the atomizer 100 from the second air inlet 222. Alternatively, in some embodiments, when the atomizer 100 is combined with some power supply mechanisms 200, the power supply mechanisms 200 may keep the first air inlet open, and cover and further close the second air inlet 222, to allow the air to enter the atomizer 100 from the first air inlet.

Referring to FIG. 2 to FIG. 7, a plurality of components for atomizing the liquid substrate and outputting the liquid substrate are arranged in the outer body or the housing 10, which specifically include:

a tubular element 60, including a first part 61, a second part 62, and a third part 63 that are sequentially arranged in a longitudinal direction. Inner diameters/outer diameters of the first part 61, the second part 62, and the third part 63 sequentially increase. The first part 61 faces toward or is close to the near end 110, and the third part 63 faces toward or is close to the far end 120. In this embodiment, the tubular element 60 is arranged in a longitudinal central axis of the atomizer 100.

After assembly, the first part 61 of the tubular element 60 is at least partially inserted into the first housing 11, and is supported or abutted by the first housing 11, to form a stop. In some embodiments, the first housing 11 is in close fitting connection to the first part 61 of the tubular element 60 in a manner of riveting, interference, or the like. The third part 63 of the tubular element 60 abuts against an insertion portion 124 in the second housing 12, to form support or abutment. The third part 63 of the tubular element 60 is in close fitting connection to the insertion portion 124 in the second housing 12 in a manner of riveting, interference, or the like.

After assembly, the tubular element 60 is substantially accommodated and held in the second housing 12. The liquid storage cavity 123 configured to store the liquid substrate is formed and defined between an outer surface of the tubular element 60 and an inner surface of the second housing 12.

As shown in FIG. 2 to FIG. 7, the atomizer 100 further includes:

a first sealing element 14, where the first sealing element 14 is prepared by using soft silica gel, a thermoplastic elastic body, or the like, and blocks and seals a side of the liquid storage cavity 123 that faces toward the near end 110. In this embodiment, the first sealing element 14 is further at least partially configured to provide sealing between the first housing 11 and the first part 61 of the tubular element 60. In this embodiment, the first part 61 of the tubular element 60 runs through the first sealing element 14 from the second housing 12, and is further inserted into or extends into the first housing 11.

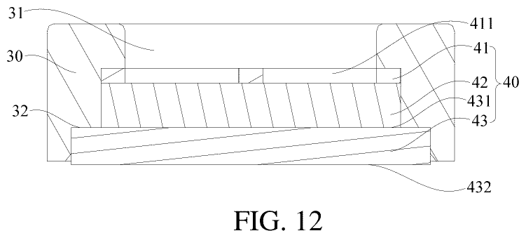

As shown in FIG. 2 to FIG. 9, FIG. 11, and FIG. 12, the atomizer 100 further includes:

the atomization assembly 40, configured to at least partially receive the liquid substrate from the liquid storage cavity 123, and heat and atomize the liquid substrate to generate the aerosol for inhalation. In this embodiment, the atomization assembly 40 is mounted or arranged between the liquid storage cavity 123 and a holder 70. In addition, in this embodiment, the atomization assembly 40 is installed or held in the holding cavity 129 defined by the second housing 12.

As shown in FIG. 2 to FIG. 9, FIG. 11, and FIG. 12, the atomization assembly 40 defines an atomization surface 432. In this embodiment, the atomization surface 432 is arranged toward the far end 120. In addition, the atomization surface 432 is arranged away from the liquid storage cavity 123.

In this embodiment, a heating element (not shown in the figure) is formed or arranged on the atomization surface 432 of the atomization assembly 40, to heat the liquid substrate to generate the aerosol. The aerosol generated by heating by using the heating element is released or overflows from the atomization surface 432. In this embodiment, the atomization surface 432 is a plane that is substantially arranged perpendicular to the longitudinal direction of the atomizer 100.

As shown in FIG. 2 to FIG. 9, the atomizer 100 further includes:

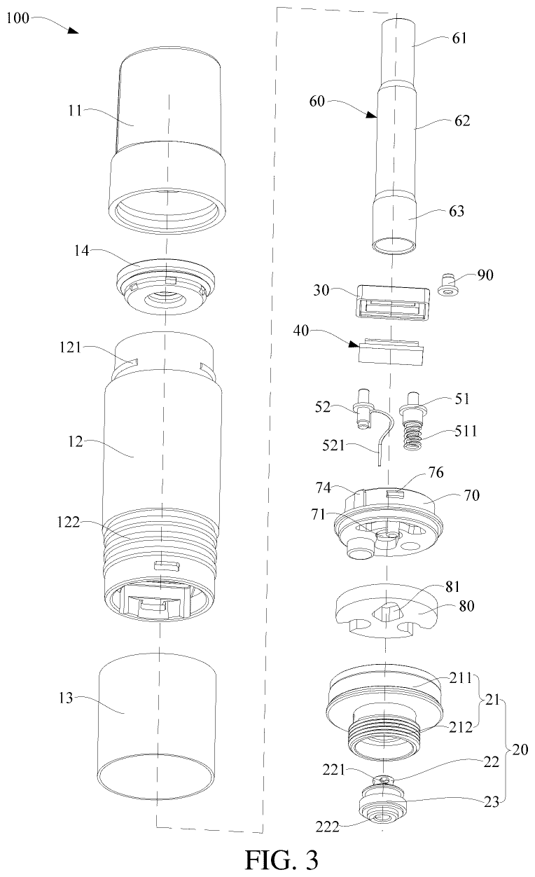

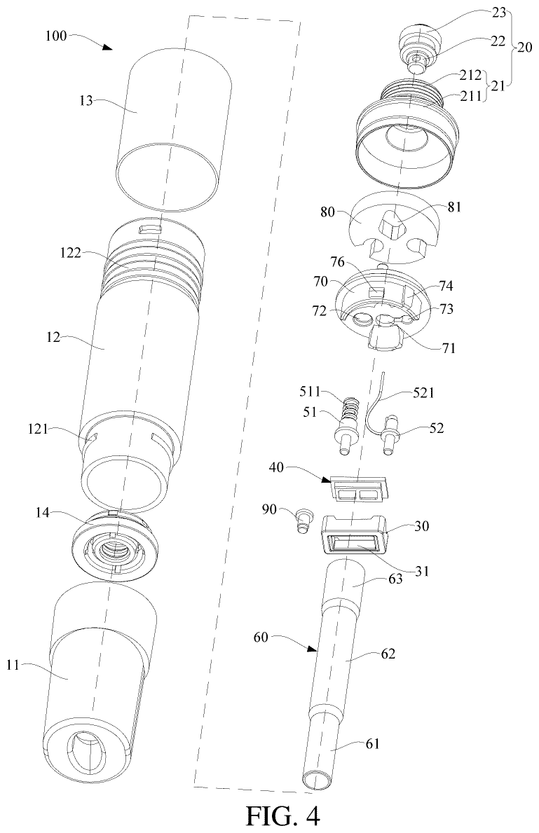

the holder 70, where the holder 70 is accommodated or mounted in the third housing 13, and is at least partially located between the second housing 12 and the first electrode 21. In some embodiments, the holder 70 is rigid. For example, the holder 70 may be prepared by using ceramic, metal, organic polymer plastic, or the like. In addition, in this embodiment, the holder 70 is mechanically connected to the second housing 12. For example, as shown in FIG. 3 and FIG. 4, a clamping protrusion 76 is arranged on the holder 70. After assembly, a part of the holder 70 extends into the second housing 12, and is connected to a clamping slot or the like on the inner surface of the second housing 12 through the clamping protrusion 76.

In the embodiments shown in FIG. 3 and FIG. 4, a first positioning structure 74 is arranged on the holder 70, and is configured to provide positioning during assembly of the holder 70 and the second housing 12. Specifically, in FIG. 3 and FIG. 4, the first positioning structure 74 is a convex edge extending in an axial direction of the holder 70. Correspondingly, a second positioning structure, for example, a recess into which the convex edge extends, matching the first positioning structure 74 is arranged on the second housing 12. In addition, after the holder 70 and the second housing 12 are assembled, the first positioning structure 74 cooperates with the second positioning structure of the second housing 12, to prevent relative rotation between the holder 70 and the second housing 12.

As shown in FIG. 2 to FIG. 9, the atomizer 100 further includes:

an atomization chamber 430, formed or defined between the atomization assembly 40 and the holder 70. More specifically, there is a spacing between the holder 70 and the atomization assembly 40/the atomization surface 432, so that the spacing forms or defines the atomization chamber 430. During use, the liquid substrate received by the atomization assembly 40 is heated by using the heating element on the atomization surface 432 to generate the aerosol, and the liquid substrate is released or overflows from the atomization surface 432 into the atomization chamber 430.

As shown in FIG. 2 to FIG. 9, the atomizer 100 further includes:

a first electrical contact 51 and a second electrical contact 52 that are spaced apart. The first electrical contact 51 is configured to provide a conductive connection between the first electrode 21 and the atomization assembly 40/the heating element, and the second electrical contact 52 is configured to provide a conductive connection between the second electrode 22 and the atomization assembly 40/the heating element.

In some embodiments, the first electrical contact 51 and/or the second electrical contact 52 substantially extend/extends in the longitudinal direction of the atomizer 100. For example, in some embodiments, the first electrical contact 51 and/or the second electrical contact 52 are constructed in a form of an elongated conductive pin. In this embodiment, the first electrical contact 51 and/or the second electrical contact 52 are/is rigid, rather than elastic pogo pins/an elastic pogo pin. In this embodiment, a length/diameter of the first electrical contact 51 is greater than a length/diameter of the second electrical contact 52. A volume of the first electrical contact 51 is relatively larger than a volume of the second electrical contact 52, which is advantageous for providing difference recognition of shapes during assembly.

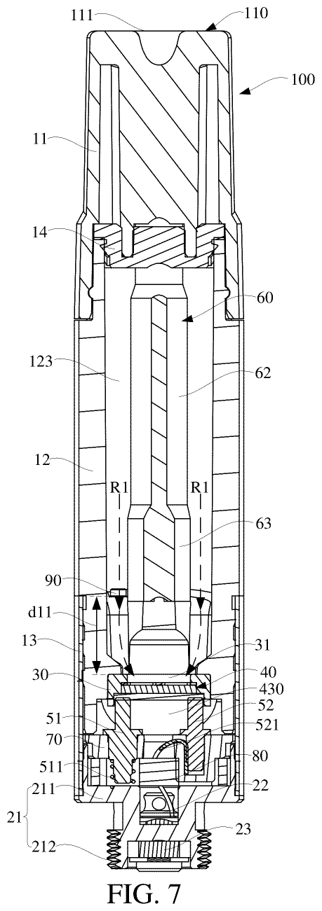

In this embodiment, the first electrical contact 51 and/or the second electrical contact 52 are/is tightly mounted or held on the holder 70. Specifically, in FIG. 3 and FIG. 4, a first contact hole 72 and a second contact hole 73 are spaced apart on the holder 70. During assembly, the first electrical contact 51 is at least partially accommodated or mounted in the first contact hole 72, and is tightly connected to the holder 70 in a manner of riveting, interference, or the like. The second electrical contact 52 is at least partially accommodated or mounted in the second contact hole 73, and is tightly connected to the holder 70 in a manner of riveting, interference, or the like. In this embodiment, the first contact hole 72 of the holder 70 is a through hole, and the first electrical contact 51 that is obtained after assembly runs through the holder 70. In addition, in this embodiment, the second contact hole 73 of the holder 70 is a blind hole, and the second electrical contact 52 does not run through the holder 70. For example, as shown in FIG. 7, the second electrical contact 52 does not extend beyond a surface of the holder 70 that faces toward the far end 120.

In this embodiment, the first electrical contact 51 and/or the second electrical contact 52 longitudinally abut/abuts against the atomization surface 432 of the atomization assembly 40, to further form electric conduction with the heating element on the atomization surface 432. In addition, after assembly, the first electrical contact 51 and/or the second electrical contact 52 longitudinally abut/abuts against the atomization surface 432 of the atomization assembly 40, to at least partially provide support for the atomization assembly 40 in a longitudinal direction.

In this embodiment, the first electrical contact 51 forms a conductive connection with the first electrode 21 through a first electrical connection element or in a first electrical connection manner. The second electrical contact 52 forms a conductive connection with the second electrode 22 through a second electrical connection element or in a second electrical connection manner. The first electrical connection element is different from the second electrical connection element; or the first electrical connection manner is different from the second electrical connection manner.

In this embodiment, the first electrical connection element includes or is a conductive spring 511. In this embodiment, the second electrical connection element is a conductive lead 521.

In this embodiment, the first electrical connection element is elastic, so that the first electrical connection element is elastically arranged between the first electrical contact 51 and the first electrode 21 and provides a conductive connection. After assembly, the first electrical connection element is at least partially compressed between the first electrical contact 51 and the first electrode 21.

In this embodiment, the second electrical connection element is bendable. During assembly, after being bent, the second electrical connection element is conductively connected to the second electrical contact 52 and/or the second electrode 22.

Specifically, in this embodiment, the first electrical contact 51 forms a conductive connection with the first electrode 21 through the conductive spring 511. As shown in FIG. 3 to FIG. 9, the first electrical contact 51 runs through the holder 70. The conductive spring 511 is a longitudinally arranged coil spring. After assembly, the conductive spring 511 at least partially surrounds the first electrical contact 51. One end of the conductive spring 511 abuts against the first electrical contact 51, and the other end of the conductive spring 511 abuts against the first electrode 21, so that a conductive connection between the first electrode 21 and the first electrical contact 51 is established by the conductive spring 511. More specifically, the conductive spring 511 abuts against the first section 211 of the first electrode 21.

Specifically, in this embodiment, the second electrical contact 52 forms a conductive connection with the second electrode 22 through the conductive lead 521. As shown in FIG. 3 to FIG. 9, one part of the elongated conductive lead 521 extends into the second contact hole 73 and abuts against an outer surface of the second electrical contact 52 to form electrical conduction, and the other part of the elongated conductive lead 521 passes through the holder 70, and then extends into the insulating element 23 and abuts against an outer surface of the second electrode 22 to form electrical conduction, so that the conductive connection between the second electrical contact 52 and the second electrode 22 is established.

As shown in FIG. 2 to FIG. 9, FIG. 11, and FIG. 12, the atomization assembly 40 includes:

a porous body element 43, forming or defining the atomization surface 432. Alternatively, the atomization surface 432 is arranged on the porous body element 43. The porous body element 43 is rigid. The heating element is formed on or integrated into the atomization surface 432 of the porous body element 43. In some embodiments, the heating element is prepared by using a resistive material, such as, a metal material with appropriate impedance, a metal alloy, graphite, carbon, conductive ceramic, or another composite material of a ceramic material and a metal material. In some embodiments, the heating element is arranged in a form of a resistive heating track, a coating, a patterned heating pattern, or the like formed on the atomization surface 432.

In some embodiments, the porous body element 43 is a liquid-permeable porous structure. In some embodiments, the porous body element 43 includes a common porous body material, for example, rigid foamed metal formed by sintering a mixture of a raw material of a base and a pore forming agent, porous ceramic, porous glass, and the like. In addition, the liquid substrates absorbed and transferred by disordered micropores are abundantly arranged inside the porous body element 43 defined by the sintered pore forming agent.

Alternatively, in still some other embodiments, the porous body element 43 includes a plurality of liquid guiding holes in a predetermined direction that are formed on a dense base material such as dense ceramic or dense glass, so that the porous body element 43 is of a porous structure. For example, in some embodiments, the liquid guiding holes in the predetermined direction in the porous body element 43 may be formed through mechanical drilling, laser boring, chemical milling, or the like. In this embodiment, the plurality of liquid guiding holes straightly and flatly extend in a thickness direction of the porous body element 43. In addition, the liquid guiding holes run through the porous body element 43 in the thickness direction of the porous body element 43. The liquid guiding holes run through or extend to the atomization surface 432 from a first surface 322. During use, the liquid substrate is delivered from a liquid absorbing surface 431 to the atomization surface 432 through capillary infiltration of the liquid guiding holes, and the liquid substrate is heated and atomized by the heating element. In addition, in this embodiment, the plurality of liquid guiding holes are sequentially provided in the porous body element 43. The plurality of liquid guiding holes extend in a predetermined direction rather than in a disordered manner. In addition, in this embodiment, the plurality of liquid guiding holes are provided in an array in the porous body element 43. In addition, in this embodiment, the plurality of liquid guiding holes can transfer the liquid substrate from the liquid absorbing surface 431 to the atomization surface 432 at a predetermined rate.

In some embodiments, the porous body element 43 is constructed in a sheet shape that is arranged perpendicular to the longitudinal direction of the atomizer 100. The liquid absorbing surface 431 and the atomization surface 432 are arranged opposite to each other in the thickness direction of the porous body element 43. In addition, the liquid absorbing surface 431 is configured to absorb or receive the liquid substrate from the liquid storage cavity 123. In still some other changeable embodiments, the porous body element 43 may also be in another regular or irregular shape, such as an arched shape. In some embodiments, the liquid absorbing surface 431 and/or the atomization surface 432 of the porous body element 43 are/is planes extending flat a plane extending flat. Alternatively, in still some other changeable embodiments, the liquid absorbing surface 431 and/or the atomization surface 432 are/is curved surfaces/a curved surface, for example, a concave arc surface or a convex arc surface.

In some embodiments, a thickness of the porous body element 43 ranges from 0.1 mm to 2 mm. More preferably, the thickness of the porous body element 43 ranges from 0.2 mm to 1 mm. Specifically, the thickness of the porous body element 43 is 0.5 mm. In addition, a length dimension of the porous body element 43 ranges from 4 mm to 8 mm. Specifically, the length dimension of the porous body element 43 may be 6 mm. In addition, a width dimension of the porous body element 43 is approximately ranges from 2 mm to 5 mm. Specifically, the length dimension of the porous body element 43 may be 3 mm.

As shown in FIG. 2 to FIG. 9, FIG. 11, and FIG. 12, the atomization assembly 40 further includes:

a flexible capillarity fiber element 42, configured to receive the liquid substrate from the liquid storage cavity 123 and hold the liquid substrate. The flexible capillarity fiber element 42 includes at least one of a cotton fiber, a cellulose fiber, a flax fiber, tencel, and a chemical synthetic fiber, for example, a non-woven fabric obtained by processing a viscose fiber. Preferably, the capillarity fiber element 42 includes a natural fiber rather than an artificial fiber. As a proper example, a thickness of a sheet-shaped capillarity fiber element 42 approximately ranges from 0.5 mm to 2 mm.

In this embodiment, the flexible capillarity fiber element 42 is combined with the liquid absorbing surface 431 of the porous body element 43. During use, the liquid absorbing surface 431 of the porous body element 43 indirectly absorbs the liquid substrate from the liquid storage cavity 123 through the capillarity fiber element 42. During use, the capillarity fiber element 42 is configured to buffer or store the liquid substrate on the liquid absorbing surface 431 or near the liquid absorbing surface 431. Alternatively, the capillarity fiber element 42 is configured as a liquid storage layer or a liquid substrate buffer layer. When the heating element combined with the atomization surface 432 starts to heat and atomize a rapidly consumed liquid substrate, the capillarity fiber element 42 can rapidly supplement the buffered or stored liquid substrate to the atomization surface 432, to prevent dry burning or gelatinization caused by instantaneous and excessive consumption of the liquid substrate on the atomization surface 432.

In this embodiment, a length and/or a width of the capillarity fiber element 42 are/is slightly less than a length or a width of the porous body element 43. After assembly, the capillarity fiber element 42 does not completely cover the liquid absorbing surface 431. In some embodiments, the length of the capillarity fiber element 42 ranges from 3 mm to 6 mm. Specifically, a length dimension of the capillarity fiber element 42 may be 5 mm. In addition, a width dimension of the capillarity fiber element 42 approximately ranges from 2 mm to 4 mm. Specifically, the width dimension of the capillarity fiber element 42 may be 2.4 mm.

As shown in FIG. 2 to FIG. 9, FIG. 11, and FIG. 12, the atomization assembly 40 further includes:

a rigid clamping element 41, combined with a side of the capillarity fiber element 42 that faces away from the porous body element 43. During use, the clamping element 41 can limit or maintain a thickness or a volume of the capillarity fiber element 42, to at least partially reduce volume expansion caused by the capillarity fiber element 42 infiltrating the liquid substrate, which is advantageous to prevent leakage of the liquid substrate caused by expansion. After assembly, the capillarity fiber element 42 is clamped between the rigid clamping element 41 and the porous body element 43. Alternatively, after assembly, the clamping element 41, the capillarity fiber element 42, and the porous body element 43 are sequentially stacked.

In this embodiment, the clamping element 41 includes at least one or more liquid through holes 411, so that the clamping element 41 is liquid-permeable. During use, the capillarity fiber element 42 absorbs the liquid substrate in the liquid storage cavity 123 through the liquid through hole 411 of the clamping element 41.

In some embodiments, the clamping element 41 may be prepared by using a rigid metal alloy such as stainless steel, ceramic, or glass. In addition, in this embodiment, the clamping element 41 is substantially in a sheet shape. In this embodiment, the clamping element 41 may be roughly in an annular shape. Alternatively, in still some other implementations, the clamping element 41 may include the plurality of or more liquid through holes 411, so that the clamping element 41 is in a mesh shape.

In this embodiment, the clamping element 41, the capillarity fiber element 42, and the porous body element 43 of the atomization assembly 40 are arranged perpendicular to the longitudinal direction of the atomizer 100. Alternatively, in still some other changeable embodiments, the clamping element 41 and/or the capillarity fiber element 42 and/or the porous body element 43 and/or the atomization surface 432 are/is obliquely arranged relative to the longitudinal direction of the atomizer 100. Alternatively, the clamping element 41 and/or the capillarity fiber element 42 and/or the porous body element 43 and/or the atomization surface 432 have/has an angle of 0 to π/2 with the longitudinal direction of the atomizer 100.

As shown in FIG. 2 to FIG. 9, FIG. 11, and FIG. 12, the atomizer 100 further includes:

a flexible second sealing element 30, arranged in an annular shape or a cylindrical shape, and at least partially surrounding or wrapping the atomization assembly 40. The second sealing element 30 may be prepared by using flexible silica gel, a thermoplastic elastic body, or the like. After assembly, the second sealing element 30 is at least partially located in the holding cavity 129 defined by the second housing 12, and provides sealing between the second housing 12 and the atomization assembly 40.

After assembly, the clamping element 41, the capillarity fiber element 42, and the porous body element 43 of the atomization assembly 40 are surrounded or encircled by the second sealing element 30. In addition, as shown in FIG. 12, an abutting step 32 is arranged in the second sealing element 30. The porous body element 43 abuts against the abutting step 32. The abutting step 32 is substantially flush with the capillarity fiber element 42. After assembly, buffer may be provided by the abutting step 32 in a longitudinal direction, to prevent the porous body element 43 from longitudinally squeezing or compressing the capillarity fiber element 42, affecting transfer efficiency of the liquid substrate. In addition, in this embodiment, the porous body element 43 and/or the clamping element 41 at least partially provide/provides support in the flexible second sealing element 30, to prevent the flexible second sealing element 30 from contracting inward to squeeze the capillarity fiber element 42, affecting the transfer efficiency of the liquid substrate.

As shown in FIG. 12, the second sealing element 30 does not extend to the atomization surface 432 of the porous body element 43. Alternatively, the second sealing element 30 avoids the atomization surface 432, which is advantageous to prevent the second sealing element 30 from being heated by the heat of the atomization surface 432/the heating element.

As shown in FIG. 2 to FIG. 9, FIG. 11, and FIG. 12, a liquid avoidance hole 31 is defined on the second sealing element 30. After assembly, the avoidance hole 31 is aligned with a liquid outlet 1231, to avoid hindering flow of the liquid substrate from the liquid outlet 1231 to the atomization assembly 40. In addition, after assembly, at least one or more liquid through holes 411 on the clamping element 41 are located in the avoidance hole 31. Further, after assembly, as shown by an arrow R1 in FIG. 3 to FIG. 9, the liquid substrate in the liquid storage cavity 123 leaves the liquid storage cavity 123 from the liquid outlet 1231, and flows to the atomization assembly 40 after passing through the liquid avoidance hole 31 of the second sealing element 30. In addition, during use, the liquid substrate transferred to the atomization assembly 40 sequentially flows through the liquid through hole 411 of the clamping element 41, the capillarity fiber element 42, and the porous body element 43, and then the liquid substrate is heated and atomized by the heating element to generate the aerosol.

During assembly, after the atomization assembly 40 is first stacked, the atomization assembly 40 is then integrally assembled into the second sealing element 30, and the atomization assembly 40 is surrounded and held by the second sealing element 30. Then, the second sealing element 30 and the atomization assembly 40 are integrally assembled into the holding cavity 129 of the second housing 12.

Alternatively, in still some other embodiments, the atomization assembly 40 may include only the clamping element 41 and the porous body element 43, and does not include the capillarity fiber element 42. In other words, the capillarity fiber element 42 is not necessarily required.

To facilitate assembly of the second sealing element 30 in the holding cavity 129 of the second housing 12, as shown in FIG. 10, the second housing 12 is further provided with:

a guide slot 1291, arranged extending from the holding cavity 129 toward the far end 120. Specifically, the guide slot 1291 is aligned with an angle of the holding cavity 129, or extends from a corner of the holding cavity 129. When the second sealing element 30 is assembled to the holding cavity 129, a corner of the second sealing element 30 may abut against or be positioned in the guide slot 1291 for positioning, and then second sealing element 30 is pushed toward the holding cavity 129 to provide guidance and positioning during assembly.

As shown in FIG. 10, a top wall of the holding cavity 129 that is close to the liquid storage cavity 123 is further provided with:

a sealing convex rib 1232, arranged in a closed annular shape around the liquid outlet 1231. After the second sealing element 30 is assembled in the holding cavity 129, the sealing convex rib 1232 abuts against the second sealing element 30 to at least partially squeeze or compress the second sealing element 30, so that sealing between the sealing convex rib 1232 and the sealing element 30 is promoted. In this way, the liquid substrate that flows from the liquid outlet 1231 to the atomization assembly 40 is prevented from leaking through the second sealing element 30 and the top wall of the holding cavity 129 that is close to the liquid storage cavity 123.

Alternatively, in still some other changeable embodiments, the sealing convex rib 1232 may also be arranged on a surface of the second sealing element 30 that faces toward the liquid storage cavity 123. The sealing convex rib 1232 may be arranged in a closed annular shape around the avoidance hole 31.

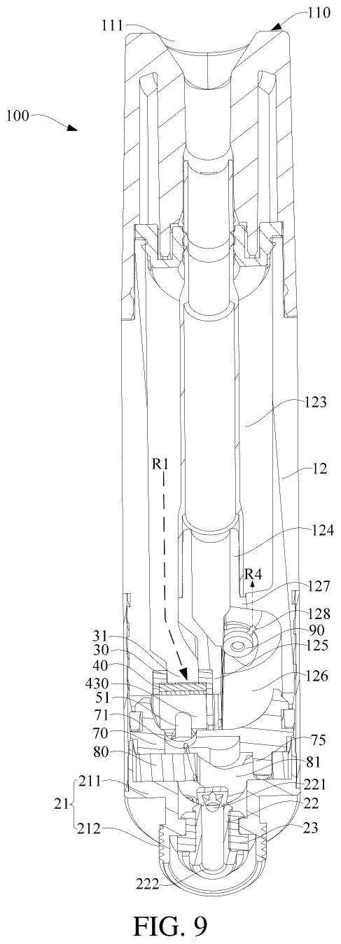

As shown in FIG. 2 in a FIG. 9, the atomizer 100 further includes:

an airflow channel, where the airflow channel defines an airflow path passing through the atomization chamber 430/the atomization surface 432 from the first air inlet 213 and/or the second air inlet 222 to the air outlet 111, to output the aerosol to the air outlet 111.

In this embodiment, a complete airflow channel is jointly defined by a plurality of components.

According to an arrow R21 and an arrow R22 in FIG. 2 to FIG. 9, the airflow channel includes:

an air inlet part, providing a path for external air to enter the atomization chamber 430 from the first air inlet 213 and/or the second air inlet 222. In this embodiment, the air inlet part may include:

a first air inlet part shown by the arrow R21, allowing the external air that enters from the first air inlet 213 to pass through an air hole 71 of the holder 70 to enter the atomization chamber 430; and/or

a second air inlet part shown by the arrow R22, allowing the external air that enters from the second air inlet 222 to pass through an air hole 71 of the holder 70 to enter the atomization chamber 430.

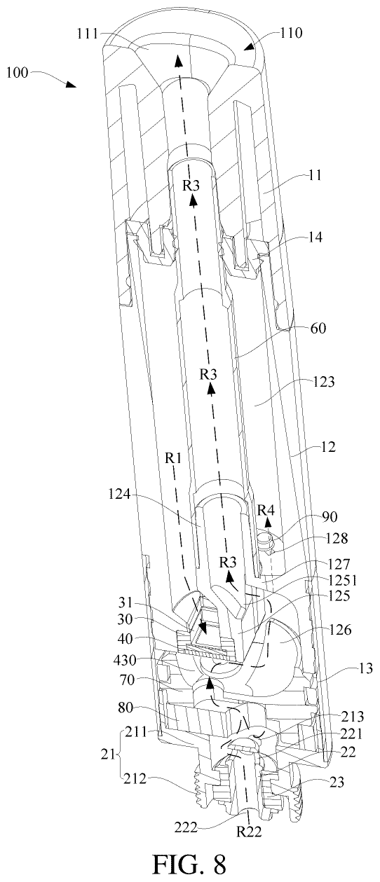

In this embodiment, the second electrode 22 is hollow, and defines a communication hole 221 exposed in the first electrode 21. In this embodiment, as shown by the arrow R22 in FIG. 8, after the external air that enters from the second air inlet 222 passes through the second electrode 22, the external air enters the first electrode 21 from the communication hole 221, and then passes through the air hole 71 of the holder 70 to enter the atomization chamber 430.

In this embodiment, in the longitudinal direction of the atomizer 100, the air hole 71 of the holder 70 is provided in alignment with the atomization surface 432 of the atomization assembly 40. Alternatively, a projection of the air hole 71 on the atomization surface 432 in the longitudinal direction of the atomizer 100 is substantially located in the atomization surface 432.

According to an arrow R3 in FIG. 2 to FIG. 9, the airflow channel further includes:

an aerosol output part, providing a path for air that carries the aerosol of the atomization chamber 430 to be output to the air outlet 111. The aerosol output part includes:

an air compartment 126, formed or defined in the second housing 12, where the air compartment 126 is in communication with the atomization chamber 430;

a hollow formed or defined in the insertion portion 124;

a hollow in the tubular element 60; and

a hollow in the first housing 11.

According to the arrow R3 in FIG. 2 to FIG. 9, after the air that is in the atomization chamber 430 and that carries the aerosol sequentially passes through the air compartment 126, the hollow in the insertion portion 124, the tubular element 60, and the hollow in the first housing 11, the air is output to the air outlet 111 to be inhaled by the user.

In this embodiment, the atomizer 100 further includes:

a porous absorbing element 80, mounted or held between the first electrode 21 and the holder 70, where the absorbing element 80 is arranged to surround or wrap the airflow channel, to absorb aerosol condensate that leaks out in a direction opposite to an airflow direction. In this embodiment, the absorbing element 80 is prepared by using a porous material such as porous fiber cotton. In this embodiment, the absorbing element 80 is constructed in an annular shape including air holes 81. The air holes 81 are configured to allow the air to pass through, so as to avoid hindering an airflow. In this embodiment, the air holes 81 of the absorbing element 80 and the air holes 71 of the holder 70 are partially overlapped and partially staggered, rather than completely aligned or overlapped.

In this embodiment, a part of the airflow channel that is surrounded and defined by the insertion portion 124, the tubular element 60, and the first housing 11 is substantially arranged in the longitudinal central axis of the atomizer 100. Alternatively, in this embodiment, a part of the airflow channel that extends in the liquid storage cavity 123 is arranged in the longitudinal central axis of the atomizer 100.

In this embodiment, the atomization assembly 40 and/or the atomization surface 432 and/or the porous body element 43 and/or the heating element are/is arranged deviating from the longitudinal central axis of the atomizer 100. In this embodiment, there is only one liquid outlet 1231. In addition, the liquid outlet 1231 deviates from the longitudinal central axis of the atomizer 100.

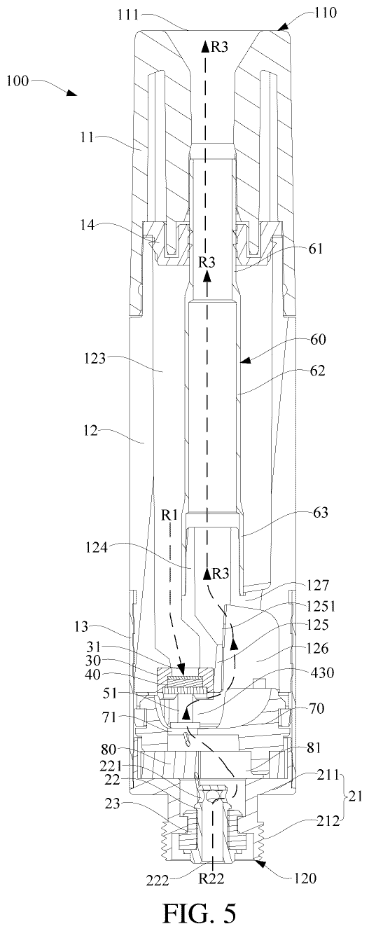

Specifically, as shown in FIG. 5 to FIG. 10, the second housing 12 is provided with:

a first separation wall 125, substantially arranged extending in the second housing 12 in a longitudinal direction of the second housing 12, where the first separation wall 125 at least partially isolates and defines the holding cavity 129. After assembly, the atomization assembly 40 and/or the holding cavity 129 are/is located on a first side of the first separation wall 125, and deviate/deviates from the longitudinal central axis of the atomizer 100. The air compartment 126 is located on a second side of the first separation wall 125 and deviates from the longitudinal central axis of the atomizer 100. In this embodiment, the first separation wall 125 provides isolation for the holding cavity 129 and the air compartment 126.

In this embodiment, the first separation wall 125 and/or the insertion portion 124 are/is integrally molded with the second housing 12.

In this embodiment, an area of the atomization surface 432 is greater than a cross-sectional area of the part of the airflow channel that is surrounded and defined by the tubular element 60. It is advantageous to hold a diluting degree of the aerosol that is generated on the atomization surface 432 and that is transferred in the tubular element 60 in a predetermined range. More preferably, the cross-sectional area of the part of the airflow channel that is surrounded and defined by the tubular element 60 is 0.3 to 0.9 times the area of the atomization surface 432. For example, in some embodiments, an inner diameter of the tubular element 60 may range from 3 mm to 4.5 mm.

In this embodiment, the insertion portion 124 is arranged extending from the first separation wall 125 toward the near end 110. An airflow communication hole 1251 is provided on the first separation wall 125. The airflow communication hole 1251 provides air communication between the air compartment 126 and the hollow in the insertion portion 124. During use, the air that carries the aerosol is output downstream through the airflow communication hole 1251 from the air compartment 126.

In this embodiment, the airflow communication hole 1251 is closer to the near end 110 than the liquid outlet 1231.

As shown in FIG. 5 to FIG. 10, the second housing 12 is provided with:

a second separation wall 127, located on the second side of the first separation wall 125. Alternatively, the second separation wall 127 extends from the first separation wall 125 to the inner surface of the second housing 12. The second separation wall 127 is substantially arranged extending perpendicular to the longitudinal direction of the atomizer 100. In this embodiment, in the longitudinal direction of the atomizer 100, the second separation wall 127 is located between the air compartment 126 and the liquid storage cavity 123.

In this embodiment, the second separation wall 127 at least partially defines a boundary of the liquid storage cavity 123 facing toward the far end 120. In this embodiment, the second separation wall 127 is closer to the near end 110 than the liquid outlet 1231.

In the embodiments shown in FIG. 3 to FIG. 10, an extending radian of the second separation wall 127 in a circumferential direction of the atomizer 100 is less than or equal to π.

As shown in FIG. 3 to FIG. 9, the atomizer 100 further includes:

a ventilation channel R4, where the ventilation channel R4 provides a channel path for communicating the liquid storage cavity 123 with the outside or the external air, to balance pressure between the liquid storage cavity 123 and the outside. More specifically, the ventilation channel R4 provides a path for communicating the liquid storage cavity 123 with the air compartment 126/airflow channel/atomization chamber 430. As shown in FIG. 3 to FIG. 9, the ventilation channel R4 runs through the second separation wall 127.

During use, when negative pressure in the liquid storage cavity 123 gradually increases as the user inhales and consumes the liquid substrate in the liquid storage cavity 123, the ventilation channel R4 can provide the channel path for the air to enter the liquid storage cavity 123 from the air compartment 126, to relieve the negative pressure in the liquid storage cavity 123. Alternatively, when an environment test is performed on the atomizer 100 or the atomizer 100 is transported at a high altitude and low pressure, if pressure in the liquid storage cavity 123 is greater than or less than pressure of the outside, the ventilation channel R4 communicates the liquid storage cavity 123 with the external air, to further balance the pressure of the liquid storage cavity 123 and the pressure of the outside.

In some embodiments, the ventilation channel R4 has a width or a diameter approximately ranging from 0.2 mm to 2.0 mm, which is advantageous to prevent the liquid substrate from leaking through the ventilation channel R4.

As shown in FIG. 3 to FIG. 10, the atomizer 100 further includes:

an air guide element 90, where the air guide element 90 is substantially in a columnar shape or a plug shape, and is arranged to run through the second separation wall 127. The air guide element 90 may be prepared by using flexible silica gel or a thermoplastic elastic body, or may be prepared by using polymer plastic or the like.

After assembly, the ventilation channel R4 is formed or defined between the air guide element 90 and the second separation wall 127. Specifically, as shown in FIG. 10, an inner wall of the second separation wall 127 that is configured to assemble or accommodate a mounting hole 1281 of the air guide element 90 is provided with a ventilation groove 128 running through in a longitudinal direction. Further, after the air guide element 90 running through the mounting hole 1281 of the second separation wall 127 is mounted, the ventilation channel R4 is defined and formed between the air guide element 90 and the second separation wall 127 by the ventilation groove 128.

In some embodiments, the airflow path for outputting the aerosol passes through the air compartment 126, so that an airflow with heat may exchange heat with the air guide element 90. In some embodiments, the air guide element 90 may be prepared by using a material such as metal with high thermal conductivity. For example, the air guide element 90 may be prepared by using an aluminum alloy, a copper alloy, a titanic alloy, or the like with thermal conductivity greater than 60 W/m·K. The air guide element 90 may be heated by the airflow passing through, and then heats a liquid substrate near the ventilation channel R4, to reduce viscosity of the liquid substrate and make ventilation smoother. Alternatively, in some other embodiments of a low-viscosity liquid substrate, the air guide element 90 may be prepared by using conventional polymer plastic with ow thermal conductivity, ceramic, silica gel, or the like.

In some embodiments, a width and/or a depth of the ventilation groove 128 range/ranges from 0.2 mm to 2.0 mm.

In this embodiment, the ventilation channel R4/the ventilation groove 128 avoid/avoids the liquid outlet 1231 of the liquid storage cavity 123 to prevent air bubbles formed by the air that enters the liquid storage cavity 123 from the ventilation channel R4 from occupying the liquid outlet 1231 and affecting liquid guiding. Specifically, in this embodiment, the liquid outlet 1231 is located on the first side of the first separation wall 125. In addition, the ventilation channel R4/the ventilation groove 128 is located on the second side of the first separation wall 125.

In this embodiment, the ventilation channel R4/ventilation groove 128 is closer to the near end 110 than the liquid outlet 1231, so that the air bubbles formed by the air that enters the liquid storage cavity 123 from the ventilation channel R4 do not flow through the liquid outlet 1231. Alternatively, the ventilation channel R4/the ventilation groove 128 is located at an air outlet port in the liquid storage cavity 123, and is provided avoiding the liquid outlet 1231. In addition, the ventilation channel R4/ventilation groove 128 that is located at the air outlet port on an inner surface of the liquid storage cavity 123 is closer to the near end 110 than the liquid outlet 1231. In a more preferred embodiment, as shown in FIG. 7, in the longitudinal direction of the atomizer 100, a height difference d11 exists between the ventilation channel R4/ventilation groove 128 that is located at the air outlet port on the inner surface of the liquid storage cavity 123 and the liquid outlet 1231. In some embodiments, the height difference d11 is at least greater than 2 mm. For example, as shown in FIG. 7, the height difference d11 is approximately 5.3 mm. Alternatively, a first distance between the liquid outlet 1231 and the near end 110 is at least 2 mm greater than a second distance between the ventilation channel R4/ventilation groove 128 that is located at the air outlet port in the liquid storage cavity 123 and the near end 110.

In this embodiment, the ventilation channel R4 and the liquid outlet 1231 are respectively located on two sides of the tubular element 60.

It should be noted that, the specification of this application and the accompanying drawings thereof illustrate preferred embodiments of this application, but is not limited to the embodiments described in the specification. Further, a person of ordinary skill in the art may make improvements or modifications according to the foregoing descriptions, and all the improvements and modifications shall fall within the protection scope of the attached claims of this application.

What is claimed is:

1. An atomizer, comprising a near end and a far end opposite to each other,
a liquid storage cavity, configured to store a liquid substrate, wherein the liquid storage cavity comprises a liquid outlet provided toward the far end;
an atomization assembly, arranged to receive the liquid substrate in the liquid storage cavity through the liquid outlet, and atomize the liquid substrate to generate an aerosol; and
a ventilation channel, wherein the ventilation channel provides a channel path for air to enter the liquid storage cavity, to adjust pressure in the liquid storage cavity; the ventilation channel comprises an air outlet port located on an inner surface of the liquid storage cavity; the air outlet port is provided avoiding the liquid outlet; and a first distance between the liquid outlet and the near end is greater than a second distance between the air outlet port and the near end.

2. The atomizer according to claim 1, wherein the first distance is at least 2 mm greater than the second distance.

3. The atomizer according to claim 1, further comprising:
a first separation wall, extending and arranged in a longitudinal direction of the atomizer, wherein the liquid outlet is located on a first side of the first separation wall, and the ventilation channel and/or the air outlet port are/is located on a second side of the first separation wall.

4. The atomizer according to claim 3, further comprising:
a holding cavity, formed or located on the first side of the first separation wall, and at least partially separated or defined by the first separation wall, wherein the atomization assembly is accommodated or held in the holding cavity; and
an air compartment, formed or located on the second side of the first separation wall, and at least partially separated or defined by the first separation wall.

5. The atomizer according to claim 4, wherein an air channel is in communication with the air compartment and the liquid storage cavity.

6. The atomizer according to claim 4, further comprising:
a second separation wall, wherein the second separation wall is at least partially located between the liquid storage cavity and the air compartment, to isolate the liquid storage cavity from the air compartment.

7. The atomizer according to claim 6, wherein the ventilation channel at least partially passes through the second separation wall; and/or
the ventilation channel is at least partially formed or provided in the second separation wall; and/or
the second separation wall is closer to the near end than the first separation wall, or the first separation wall is located between the second separation wall and the far end.

8. The atomizer according to claim 6, further comprising:
an air guide element, at least partially running through the second separation wall from the air compartment to the liquid storage cavity, wherein the ventilation channel is at least partially formed between the air guide element and the second separation wall.

9. The atomizer according to claim 8, further comprising:
an air inlet, an air outlet, and an airflow channel located between the air inlet and the air outlet, wherein the airflow channel defines an airflow path that passes through an atomization surface from the air inlet to the air outlet, to transfer the aerosol to the air outlet; the airflow channel at least partially flows through the air compartment and/or the air guide element; and
the air guide element is capable of being heated by an airflow that flows through the air compartment and/or the air guide element, and then heats a liquid substrate near the air guide element to reduce viscosity of the liquid substrate.

10. The atomizer according to claim 1, wherein the atomization assembly comprises:
a porous body element, configured to receive and hold the liquid substrate from the liquid storage cavity, and comprising an atomization surface arranged toward the far end; and
a heating element, combined with or arranged on the atomization surface, and configured to heat the liquid substrate to generate the aerosol.

11. The atomizer according to claim 10, further comprising:
an air inlet, an air outlet, and an airflow channel located between the air inlet and the air outlet, wherein the airflow channel defines an airflow path that passes through the atomization surface from the air inlet to the air outlet, to transfer the aerosol to the air outlet; and
a part of the airflow channel extends in the liquid storage cavity in a longitudinal direction of the atomizer, or a part of the airflow channel passes through the liquid storage cavity in the longitudinal direction of the atomizer.

12. The atomizer according to claim 11, wherein the part of the airflow channel that extends in the liquid storage cavity is substantially provided in a longitudinal central axis of the atomizer; and
the atomization surface is arranged deviating from the longitudinal central axis of the atomizer.

13. The atomizer according to claim 12, wherein an area of the atomization surface is greater than a cross-sectional area of the part of the airflow channel that extends in the liquid storage cavity.

14. The atomizer according to claim 12, wherein a ratio of a cross-sectional area of the part of the airflow channel that extends in the liquid storage cavity to an area of the atomization surface ranges from 0.3 and 0.9.

15. The atomizer according to claim 10, further comprising:
a first electrode and a second electrode, configured to guide a current on the heating element; and
a first electrical contact and a second electrical contact that are spaced apart, wherein the first electrical contact is configured to at least partially provide a conductive connection between the first electrode and the heating element; and the second electrical contact is configured to at least partially provide a conductive connection between the second electrode and the heating element.

16. The atomizer according to claim 15, further comprising:
an elastic first electrical connection element, wherein the elastic first electrical connection element is arranged between the first electrical contact and the first electrode, and a conductive connection between the first electrical contact and the first electrode is established; and the first electrical connection element is at least partially compressed between the first electrical contact and the first electrode; and/or
a bendable second electrical connection element, wherein the bendable second electrical connection element is bendably arranged between the second electrical contact and the second electrode, and a conductive connection between the second electrical contact and the second electrode is established.

17. The atomizer according to claim 10, wherein the atomization assembly further comprises:
a flexible capillarity fiber element, configured to absorb the liquid substrate from the liquid storage cavity, wherein
the porous body element is arranged to indirectly absorb, from the capillarity fiber element, the liquid substrate from the liquid storage cavity.

18. The atomizer according to claim 17, wherein the atomization assembly further comprises:
a rigid clamping element, combined with a side of the capillarity fiber element facing away from the porous body element, wherein the capillarity fiber element is clamped between the clamping element and the porous body element.

19. An atomizer, comprising a near end and a far end opposite to each other in a longitudinal direction,
a liquid storage cavity, configured to store a liquid substrate, wherein the liquid storage cavity comprises a liquid outlet provided toward the far end;
an atomization assembly, arranged to receive the liquid substrate in the liquid storage cavity through the liquid outlet, and atomize the liquid substrate to generate an aerosol;
a ventilation channel, wherein the ventilation channel provides a channel path for air to enter the liquid storage cavity, to adjust pressure in the liquid storage cavity; and the ventilation channel comprises an air outlet port located on an inner surface of the liquid storage cavity, and the air outlet port is provided avoiding the liquid outlet; and
a first separation wall, extending and arranged in a longitudinal direction of the atomizer, wherein the liquid outlet and the atomization assembly are located on a first side of the first separation wall, and the ventilation channel and the air outlet port are located on a second side of the first separation wall; and the liquid outlet and the air outlet port are located at different height positions in the longitudinal direction of the atomizer.

20. An electronic atomization device, comprising the atomizer according to claim 1, and a power supply mechanism that supplies power to the atomizer.
